(19) United States
(12) Patent Application Publication
(10) Pub. No.: US 2019/0057102 A1
(43) Pub. Date: Feb. 21, 2019

(54) Real-Time User Text Classification to Establish Colloquial Naming

(71) Applicant: International Business Machines Corporation, Armonk, NY (US)

(72) Inventors: Robert H. Grant, Austin, TX (US); Jeremy A. Greenberger, Raleigh, NC (US); Trudy L. Hewitt, Cary, NC (US); Joseph J. Lam, Ontario (CA)

(21) Appl. No.: 15/677,346

(22) Filed: Aug. 15, 2017

(51) Int. Cl. G06F 17/30; G06N 7/00; G06N 99/00

(52) U.S. Cl. CPC G06F 17/3087; G06F 17/3053; G06N 99/005; G06F 17/30707; G06N 7/005; G06F 17/30867

(57) ABSTRACT

A mechanism is provided in a data processing system comprising at least one processor and at least one memory, the at least one memory comprising instructions which are executed by the at least one processor and configure the processor to implement a cognitive monitoring engine, a location determination engine, and an analysis engine to establish colloquial naming and to augment location attributes. The cognitive monitoring engine performs monitoring of a conversation. Responsive to the cognitive monitoring engine identifying a location/time pair in the conversation, the mechanism sets an alarm to trigger at the time in the location/time pair. Responsive to the alarm triggering, the location determination engine determines a location of the user. The mechanism searches for an official name associated with the determined location of the user. The analysis engine determines a confidence score representing a confidence that the location in the location/time pair is a colloquial name for the official name. Responsive to the analysis engine determining that the confidence score is greater than a threshold, the mechanism adds the official name and the colloquial name to a mapping data structure.

### BACKGROUND

The present application relates generally to an improved data processing apparatus and method and more specifically to mechanisms for using real-time user text classification to establish colloquial naming.

It is very common when researching the name of a location, such as a store, restaurant, or other business, to find similarly named locations, especially when the name used is a colloquial name. Frequently, businesses have insider names that change frequently and are not a part of large search engines. This can make them difficult to find and result in reduced physical and virtual traffic. People frequently use these colloquial names to talk with friends and to invite them to meetings or gatherings. People also provide descriptors to better enable the person to find the location; however, it still may be difficult to find a location.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in a data processing system comprising at least one processor and at least one memory, the at least one memory comprising instructions which are executed by the at least one processor and configure the processor to implement a cognitive monitoring engine, a location determination engine, and an analysis engine to establish colloquial naming and to augment location attributes. The method comprises performing, by the cognitive monitoring engine, monitoring of a conversation. Responsive to the cognitive monitoring engine identifying a location/time pair in the conversation, the method comprises setting an alarm to trigger at the time in the location/time pair. Responsive to the alarm triggering, the location determination engine determines a location of the user. The method further comprises searching for an official name associated with the determined location of the user. The analysis engine determines a confidence score representing a confidence that the location in the location/time pair is a colloquial name for the official name. Responsive to the analysis engine determining that the confidence score is greater than a threshold, the method comprises adding the official name and the colloquial name to a mapping data structure.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is a block diagram illustrating a mechanism for using real-time text classification to establish colloquial naming and to augment location attributes in accordance with an illustrative embodiment; and

FIG. 4 is a flowchart illustrating operation of a mechanism for using real-time user text classification to establish colloquial naming and to augment location attributes in accordance with an illustrative embodiment.

### DETAILED DESCRIPTION

The illustrative embodiments provide mechanisms for using real-time text classification to establish colloquial naming and to augment location attributes. The illustrative embodiments provide a mechanism for performing cognitive monitoring of real-time conversational text to identify location/time pairs and contextual descriptors. The mechanism generates colloquial names and descriptors for locations and businesses, such as restaurants, bars, hotels, stores, etc. Upon encountering classified phrases, such as “let's meet up at restaurant for dinner at 9 pm,” the mechanism engages an alarm to trigger at the given time while using entity analysis to extract the location name (restaurant) and descriptor (dinner). When the alarm triggers, the mechanism determines a location of the user and searches for known names of businesses in that area. The name typed by the user is then compared to the name provided by the result of the search to determine whether the name used was colloquial. Additionally, the descriptor is compared to the existing list for that location.

The mechanism generates a confidence score indicating a confidence that the colloquial name is used in place of the official name of a business at the user's location. If the confidence score is greater than a threshold, the mechanism may add the colloquial name, and optionally the descriptor, to the search engine index to enhance search results provided by the search engine.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

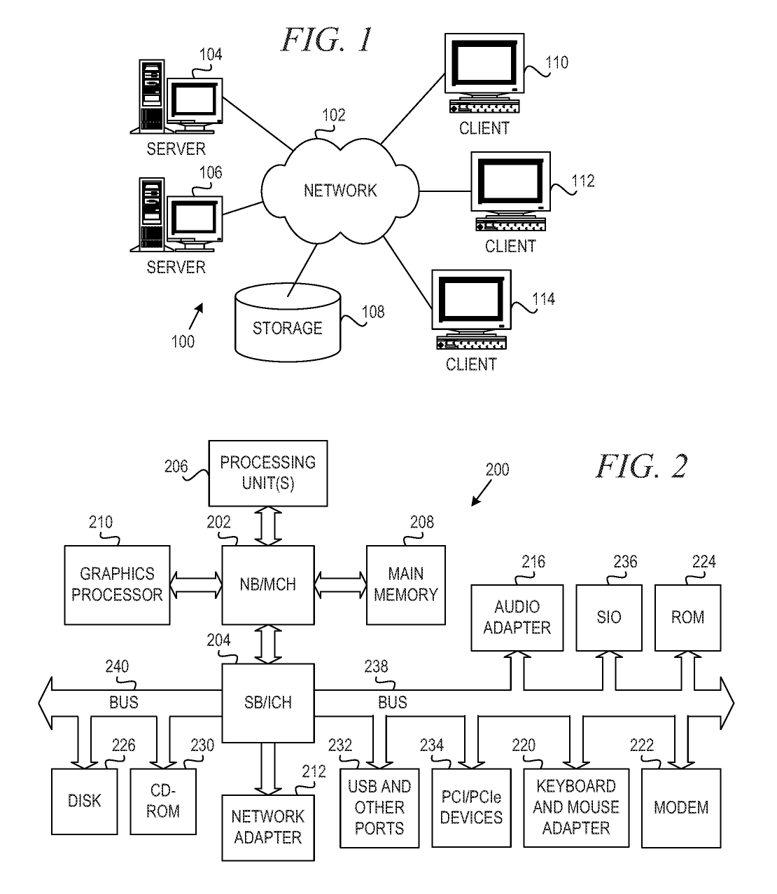

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement a mechanism for using real-time user text classification to establish colloquial naming and to augment location attributes. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates using real-time user text classification to establish colloquial naming and to augment location attributes.

In one embodiment, a cognitive monitoring engine is provided in client application or server application for a real-time conversation service, such as the SKYPE™ service from Microsoft Corporation, the WHATSAPPrM service from WhatsApp Inc., the IMESSAGE™ service from Apple, Inc., etc. Alternatively, the cognitive monitoring engine also could be implemented in social media services, email services, short message service (SMS) applications, team collaboration services. In alternative embodiments, the cognitive monitoring engine may be implemented within intelligent assistant services, such as the CORTANA™ intelligent assistant service from Microsoft Corporation, the SIRI™ intelligent assistant service from Apple, Inc., the GOOGLE ASSISTANT™ intelligent assistant service from Google, Inc., the ALEXA™ intelligent assistant service from Amazon.com, Inc., or the like. Thus, the cognitive monitoring engine may be implemented as an agent, bot, assistant, skill, or the like in the above-mentioned developing platforms. Furthermore, the cognitive monitoring engine may be implemented in server 104 or client 110, for example.

The illustrative embodiments also provide other mechanisms or engines that start timers, determine location, perform searches, and perform analysis. These mechanisms or engines may be implemented across various devices, such as personal computers, smartphone devices, tablets, and servers. For example, an engine for starting and monitoring a timer may exist on a user's smartphone device, an engine for determining location may exist on a combination of a user's smartphone device and a server, and an engine for analyzing search results may exist on a server.

As noted above, the mechanisms of the illustrative embodiments utilize specifically configured computing devices, or data processing systems, to perform the operations for establishing colloquial naming and augmenting location attributes. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 or client 110 in FIG. 1, in which computer usable code or instructions implementing the processes and aspects of the illustrative embodiments of the present invention may be located and/or executed so as to achieve the operation, output, and external affects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the mechanisms for establishing colloquial naming and augmenting location attributes.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

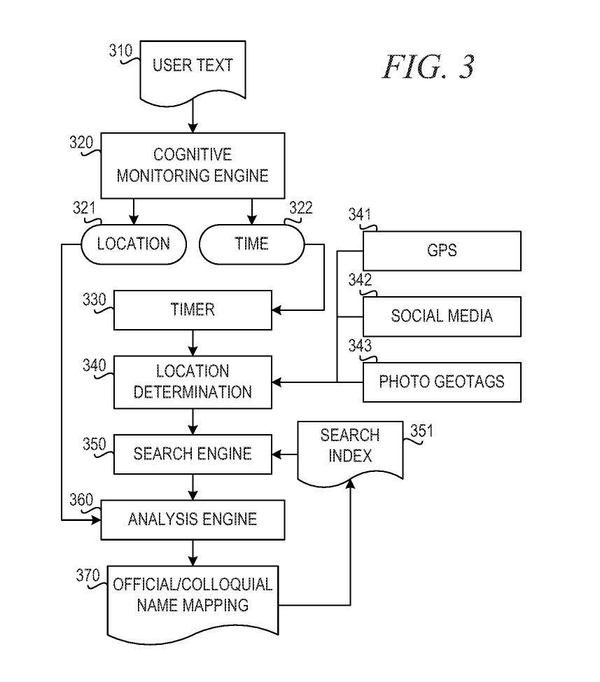

FIG. 3 is a block diagram illustrating a mechanism for using real-time text classification to establish colloquial naming and to augment location attributes in accordance with an illustrative embodiment. Cognitive monitoring engine 320 receives and monitors user text 310. Cognitive monitoring engine 320 may perform cognitive services, such providing chat bots, natural language understanding and classification, entity extraction, and the like. Cognitive monitoring engine 320 may be implemented as client software, server software, or as part of a cloud service as an agent or bot in a text communication or social media service, or as a skill in an intelligent assistant service, for example. Furthermore, the cognitive services performed by cognitive monitoring engine 320 may be client-side software, server-side software, or cloud services.

Cognitive monitoring engine 320 performs natural language classification to determine process initiation from user text 310 based on meeting verbs, time, and location entities. As an example, user text 310 may include the following question: “Do you want to meet up for dinner at Gen's at 9 pm?” Cognitive monitoring engine 320 performs natural language classification and entity extraction to detect the phrase “meet up” as an indicator of a meeting among multiple participants, the term “dinner” as a descriptor of a location or time, the term “Gen's” as a location, and the text “9 pm” as a time. Thus, cognitive monitoring engine 320 detects a location/time pair including location 321 (Beasley's) and time 322 (9 pm).

In another embodiment, the mechanism may perform trending analysis on when the user typically eats dinner in comparison to other users in the group. For example, dinner time could vary for users depending on their work schedule or shift, preferences, availability, etc. Furthermore, mechanism may determine that the phrase “meet up” indicates a particular type of meeting (e.g., casual, not formal).

The mechanism uses time entity 322 to set timer 330 such that timer 330 generates an alarm when the time 322 is reached. In response to the alarm, location determination engine 340 determines the location of the user. In one embodiment, location determination engine 340 determines the location of the user's mobile device using global positioning system (GPS) component 341. In one example embodiment, location determination engine 340 may track the location of the user before or after the given time 322 to enhance results or establish confidence.

Alternatively or in addition, location determination engine 340 may use social media 342 or photograph geotag component 343 to determine the location of the user. For instance, location determination engine 340 may use social media component 342 to determine whether the user used a “check in” feature of a social network to mark the user's location. Location determination engine 340 may also employ photo geotag component 343 to examine photographs taken by the user and determine if a photograph has a timestamp matching time 322 and a geotag with geographic location information.

Search engine 350 uses location information from location determination engine 340 to perform a search of the location, which may be in the form of longitude and latitude components or an address. Search engine 350 may search using search index 351 to determine whether there is a business or other place at the identified location. Search engine 350 then provides an identified business or other location name.

Analysis engine 360 compares the location 321 from user text 310 to the business or location name from search engine 350. Analysis engine 360 analyzes the location 321 and the official business name from search engine 350 to determine a similarity score or confidence score based on a number of factors. Primarily, analysis engine 360 compares the linguistic similarities of the location 321 and the business name to determine a similarity score. For instance, location 321 may be a shortened form of the official business name. As an example, “Gen's” may be a shortened form of “Generic Restaurant and Meeting Place.” The term “Gen's” would have a higher similar score than “G's,” for example.

In another embodiment, analysis engine 360 may examine the user's search history to determine if the user previously performed a search for the identified business name to obtain an address or directions. Analysis engine 360 may also examine a location history of the user to determine whether the user has been to the location of the business frequently in the past. Analysis engine 360 may also determine whether other participants of the conversation in user text 310 were at the same location at the same time at time 322 or in the past.

Analysis engine 360 generates a confidence score for the business or location name provided by search engine 350. Analysis engine 360 may determine the confidence score based at least in part on a similarity score representing how similar location 321 from user text 310 is to the official business name provided by search engine 350. Analysis engine 360 may also determine the confidence score based on a number of other factors or features.

In one embodiment, analysis engine 360 uses a machine learning technique to generate the confidence score based on a set of features of the location 321, the location provided by search engine 350, a descriptor in user text 310, and other possible attributes. The machine learning technique may be, for example, classification, regression, or clustering.

Analysis engine 360 compares the confidence score to a predetermined threshold. If the confidence score exceeds the threshold, then compare/score engine 360 determines that the location 321 is a colloquial name for the official business name provided by searching engine 350. In this case, analysis engine 360 adds the location 321 and the location provided by search engine 350 to official/colloquial name mapping data structure 370.

The mechanism may use information in official/colloquial name mapping data structure 370 to update search index 351. For example, the record for “Generic Restaurant and Meeting Place” in search index 351 may specify “name: Generic Restaurant and Meeting Place,” and the mechanism of FIG. 3 may augment the record with the following:

alt.name: Gen's

attribute: restaurant, dinner

Information may be stored locally or on external services to provide personalized experience. Information may be established contextually. The illustrative embodiments may apply to various location types, such as restaurants, sporting venues, stores, bars, public facilities, parks, etc.

In one embodiment, the mechanism may adapt naming as conversation progresses. For example, if a new person joins the conversation, the mechanism may continue to perform cognitive analysis on the conversation as the new person may introduce new alternative naming examples.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

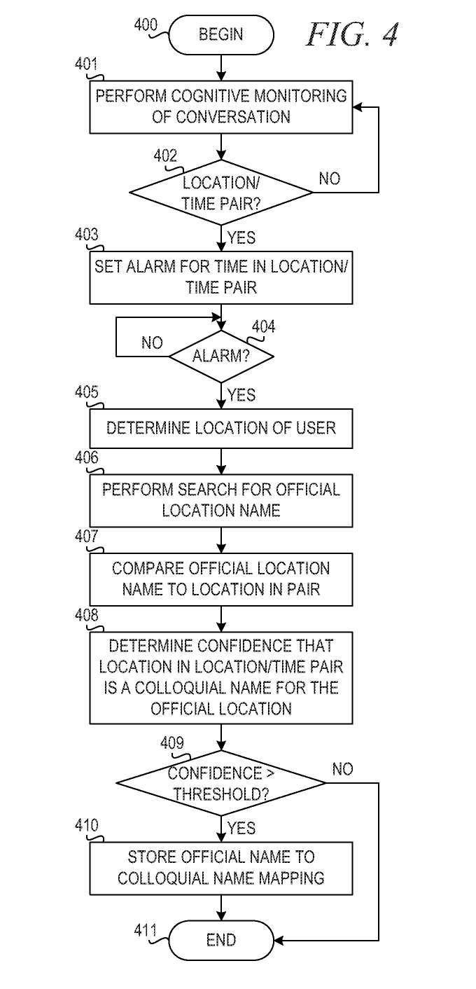

FIG. 4 is a flowchart illustrating operation of a mechanism for using real-time user text classification to establish colloquial naming and to augment location attributes in accordance with an illustrative embodiment. Operation begins (block 400), and the mechanism performs cognitive monitoring of a conversation (block 401). The mechanism determines whether a location/time pair is encountered in the conversation (block 402). If a location/time pair is not encountered, the mechanism returns to block 401 to perform cognitive monitoring of the conversation.

If a location/time pair is encountered in block 402, the mechanism sets an alarm for the time in the location/time pair (block 403). The mechanism determines whether the alarm is triggered (block 404). The alarm is triggered when a current time matches the time in the alarm, i.e., the time in the location/time pair. If the alarm is not triggered, then operation returns to block 404.

If the alarm is triggered in block 404, then the mechanism determines a location of the user (block 405). As discussed above, the mechanism may determine the location using a global positioning system (GPS), social media check-in information, or photograph geotagging, for example. The mechanism performs a search for an official location name for the determined user location (block 406). The mechanism may perform the search using a search engine, such as a common search engine with map capabilities, restaurant reviews, etc.

The mechanism compares the official location name to the location in the location/time pair (block 407). In one embodiment, the mechanism determines a similarity score representing how linguistically similar the location in the location/time pair is to the official location name from the search engine. The mechanism then determines a confidence score representing a confidence that the location in the location/time pair is a colloquial name for the official location name (block 408).

The mechanism then determines whether the confidence score is greater than a threshold (block 409). If the confidence score is not greater than the threshold, then operation ends (block 411).

If the confidence score is greater than the threshold in block 409, then the mechanism stores the colloquial location name and the official location name in an official name to colloquial name mapping data structure (block 410). Thereafter, operation ends (block 411). In one embodiment, the mechanism stores the official name to colloquial name in the search index of the search engine to augment the search index to include colloquial names. In an example embodiment, the mechanism also augments the search index with a descriptor or other contextual information to improve search results.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions which are executed by the at least one processor and configure the processor to implement a cognitive monitoring engine, a location determination engine, and an analysis engine to establish colloquial naming and to augment location attributes, the method comprising:
performing, by the cognitive monitoring engine, monitoring of at least one conversation;
responsive to the cognitive monitoring engine identifying a location/time pair in the at least one conversation, setting a timer to trigger at the time in the location/time pair;
responsive to the timer triggering, determining, by the location determination engine, a location of the user;
searching for an official name associated with the determined location of the user,
determining, by the analysis engine, a confidence score representing a confidence that the location in the location/time pair is a colloquial name for the official name; and
responsive to the analysis engine determining that the confidence score is greater than a threshold, adding the official name and the colloquial name to a mapping data structure.

2. The method of claim 1, wherein searching for the official name associated with the determined location comprises using a search engine to search a search index for the determined location.

3. The method of claim 2, further comprising augmenting the search index based on information in the mapping data structure.

4. The method of claim 1, wherein performing monitoring of the at least one conversation comprises performing natural language classification of text in the conversation.

5. The method of claim 1, wherein determining the location of the user comprises using a global positioning system to determine a location of a mobile device associated with the user.

6. The method of claim 1, wherein determining the location of the user comprises obtaining location information from a social media source.

7. The method of claim 1, wherein determining the confidence score comprises generating similarity score representing a degree to which the location in the location/time pair is linguistically similar to the official name associated with the determined location.

8. The method of claim 1, wherein determining the confidence score comprises using a machine learning technique to generate the confidence score.

9. The method of claim 1, wherein determining the confidence score comprises determining the confidence score based on a location history of the user.

10. The method of claim 1, wherein the at least one conversation comprises a multiple user chat, an email exchange, or a social media conversation.

11. A computer program product comprising a computer readable storage medium having a computer readable program stored therein, wherein the computer readable program, when executed on a computing device, causes the computing device to implement a cognitive monitoring engine, a location determination engine, and an analysis engine to establish colloquial naming and to augment location attributes, wherein the computer readable program causes the computing system to:
perform, by the cognitive monitoring engine, monitoring of at least one conversation;
responsive to the cognitive monitoring engine identifying a location/time pair in the at least one conversation, set a timer to trigger at the time in the location/time pair;
responsive to the timer triggering, determine, by the location determination engine, a location of the user;
search for an official name associated with the determined location of the user;
determine, by the analysis engine, a confidence score representing a confidence that the location in the location/time pair is a colloquial name for the official name; and
responsive to the analysis engine determining that the confidence score is greater than a threshold, add the official name and the colloquial name to a mapping data structure.

12. The computer program product of claim 11, wherein searching for the official name associated with the determined location comprises using a search engine to search a search index for the determined location.

13. The computer program product of claim 12, wherein the computer readable program further causes the computing system to augment the search index based on information in the mapping data structure.

14. The computer program product of claim 11, wherein performing monitoring of the at least one conversation comprises performing natural language classification of text in the conversation.

15. The computer program product of claim 11, wherein determining the location of the user comprises using a global positioning system to determine a location of a mobile device associated with the user.

16. The computer program product of claim 11, wherein determining the location of the user comprises obtaining location information from a social media source.

17. The computer program product of claim 11, wherein determining the confidence score comprises generating similarity score representing a degree to which the location in the location/time pair is linguistically similar to the official name associated with the determined location.

18. The computer program product of claim 11, wherein determining the confidence score comprises using a machine learning technique to generate the confidence score.

19. The computer program product of claim 11, wherein determining the confidence score comprises determining the confidence score based on a location history of the user.

20. An apparatus comprising:
at least one processor; and
at least one memory coupled to the at least one processor, wherein the at least one memory comprises instructions which, when executed by the at least one processor, cause the at least one processor to implement a read-ahead manager for adaptive read-ahead in log structured storage, wherein the instructions cause the at least one processor to implement a cognitive monitoring engine, a location determination engine, and an analysis engine to establish colloquial naming and to augment location attributes, wherein the instructions cause the at least one processor to:
perform, by the cognitive monitoring engine, monitoring of at least one conversation;
responsive to the cognitive monitoring engine identifying a location/time pair in the at least one conversation, set a timer to trigger at the time in the location/time pair;
responsive to the timer triggering, determine, by the location determination engine, a location of the user;
search for an official name associated with the determined location of the user;
determine, by the analysis engine, a confidence score representing a confidence that the location in the location/time pair is a colloquial name for the official name; and
responsive to the analysis engine determining that the confidence score is greater than a threshold, add the official name and the colloquial name to a mapping data structure.
